(19) United States
(12) Patent Application Publication
(10) Pub. No.: US 2013/0176513 A1
(43) Pub. Date: Jul. 11, 2013

(54) LIQUID CRYSTAL DISPLAY APPARATUS

(71) Applicant: Yuki SATO, Tokyo (JP)

(72) Inventor: Yuki SATO, Tokyo (JP)

(21) Appl. No.: 13/731,915

(22) Filed: Dec. 31, 2012

(30) Foreign Application Priority Data
Jan. 5, 2012 (JP) 2012-000694

(51) Int. Cl. G02F 1/1333

(52) U.S. Cl. CPC G02F 1/1333
USPC 349/33

(57) ABSTRACT

A liquid crystal display apparatus includes: a liquid crystal display panel, which is an in-plane switching type and has liquid crystals sealed between two insulating substrates to be applied a horizontal electric field to the liquid crystals; a conductive film that is formed on a display surface side of the liquid crystal display panel; a backlight that illuminates the liquid crystal display panel from a backside that is opposite to the display surface; and a conductive tape that is adhered over the conductive film and a metal member configuring the backlight, wherein the conductive tape has a stress absorption part that is provided between an end portion of the liquid crystal display panel and an end portion of the backlight, which is arranged to face the end portion of the liquid crystal display panel, to absorb stress to be applied to the conductive tape.

### CROSS-REFERENCE TO RELATED APPLICATION

This application claims priority from Japanese Patent Application No. 2012-000694 filed on Jan. 5, 2012, the entire subject matter of which is incorporated herein by reference.

### TECHNICAL FIELD

This disclosure relates to a liquid crystal display apparatus having a liquid crystal display panel of an in-plane switching type.

### BACKGROUND

As shown in FIGS. 6 and 7 of JP-A-2008-83308, a background liquid crystal display apparatus of an in-plane switching type has a metal frame, a liquid crystal material (liquid crystal display panel) and a backlight unit. Also, a conductive tape is adhered to an opposite substrate side polarizing plate at a display surface side of the liquid crystal material and the metal plate or a backlight metal part configuring the backlight unit, so that static electricity to be charged to the display surface side is discharged.

### SUMMARY

However, the liquid crystal display panel may move in all directions by deformation due to an external force or by a slight clearance between the respective members. When the liquid crystal display panel moves, stress is applied to the conductive tape adhered to the display surface side, so that the conductive tape is peeled off from the liquid crystal display panel or metal frame. When the conductive tape is peeled off, the place to which the static electricity to be charged is discharged is lost and the static electricity distracts an orientation of liquid crystals. As a result, a display defect is caused.

This disclosure provides at least a liquid crystal display apparatus of an in-plane switching type capable of preventing a conductive tape from being peeled off due to stress applied to a liquid crystal display panel to thus prohibit a display defect from occurring, which is caused due to the peeling off of the conductive tape, thereby improving the reliability.

A liquid crystal display apparatus of this disclosure comprises: a liquid crystal display panel, which is an in-plane switching type and has liquid crystals sealed between two insulating substrates to be applied a horizontal electric field to the liquid crystals; a conductive film that is formed on a display surface side of the liquid crystal display panel; a backlight that illuminates the liquid crystal display panel from a backside that is opposite to the display surface; and a conductive tape that is adhered over the conductive film and a metal member configuring the backlight, wherein the conductive tape has a stress absorption part that is provided between an end portion of the liquid crystal display panel and an end portion of the backlight, which is arranged to face the end portion of the liquid crystal display panel, to absorb stress to be applied to the conductive tape.

According to this disclosure, the stress absorption part that absorbs the stress to be applied to the conductive tape is provided between the end portion of the liquid crystal display panel and the end portion of the backlight, which is arranged to face the end portion of the liquid crystal display panel. Therefore, the stress applied to the conductive tape is reduced to prevent the problem that the conductive tape is peeled off due to the stress transferred from the liquid crystal display panel to the conductive tape. Thus, it is possible to prevent the conductive tape from being peeled off. As a result, it is possible to prevent the orientation of the liquid crystals from being distracted due to the charging of the liquid crystal display panel, which is caused due to the peeling off of the conductive tape, thereby reducing the display defects.

### BRIEF DESCRIPTION OF THE DRAWINGS

The foregoing and additional features and characteristics of this disclosure will become more apparent from the following detailed descriptions considered with the reference to the accompanying drawings, wherein:

FIG. 1 is an exploded perspective view illustrating a liquid crystal display apparatus according to an illustrative embodiment of this disclosure;

FIG. 2 is a front view illustrating the liquid crystal display apparatus according to an illustrative embodiment of this disclosure;

FIG. 3A is a sectional view illustrating the liquid crystal display apparatus of FIG. 2, which is taken along a line 3A-3A, and FIG. 3B is a front view illustrating a conductive tape;

FIG. 4 is a front view illustrating the conductive tape used in the liquid crystal display apparatus of this disclosure;

FIG. 5A, 5B and 5C front views illustrating conductive tapes that are used in the liquid crystal display apparatus of this disclosure;

FIG. 6A is a sectional view illustrating the liquid crystal display apparatus of this disclosure, and FIG. 6B is a backside view illustrating a conductive tape;

FIG. 7A is a sectional view illustrating the liquid crystal display apparatus of this disclosure, and FIG. 7B is a backside view illustrating a conductive tape;

FIG. 8A is a front view illustrating the liquid crystal display apparatus of this disclosure, and FIG. 8B a backside view illustrating a conductive tape; and

FIG. 9 is a backside view illustrating a conductive tape used in the liquid crystal display apparatus of this disclosure.

### DETAILED DESCRIPTION

### First Illustrative Embodiment

A configuration of a liquid crystal display apparatus according to an illustrative embodiment of this disclosure will be described with reference to the drawings. In the meantime, the same reference numerals in the respective drawings indicate the substantially same configurations.

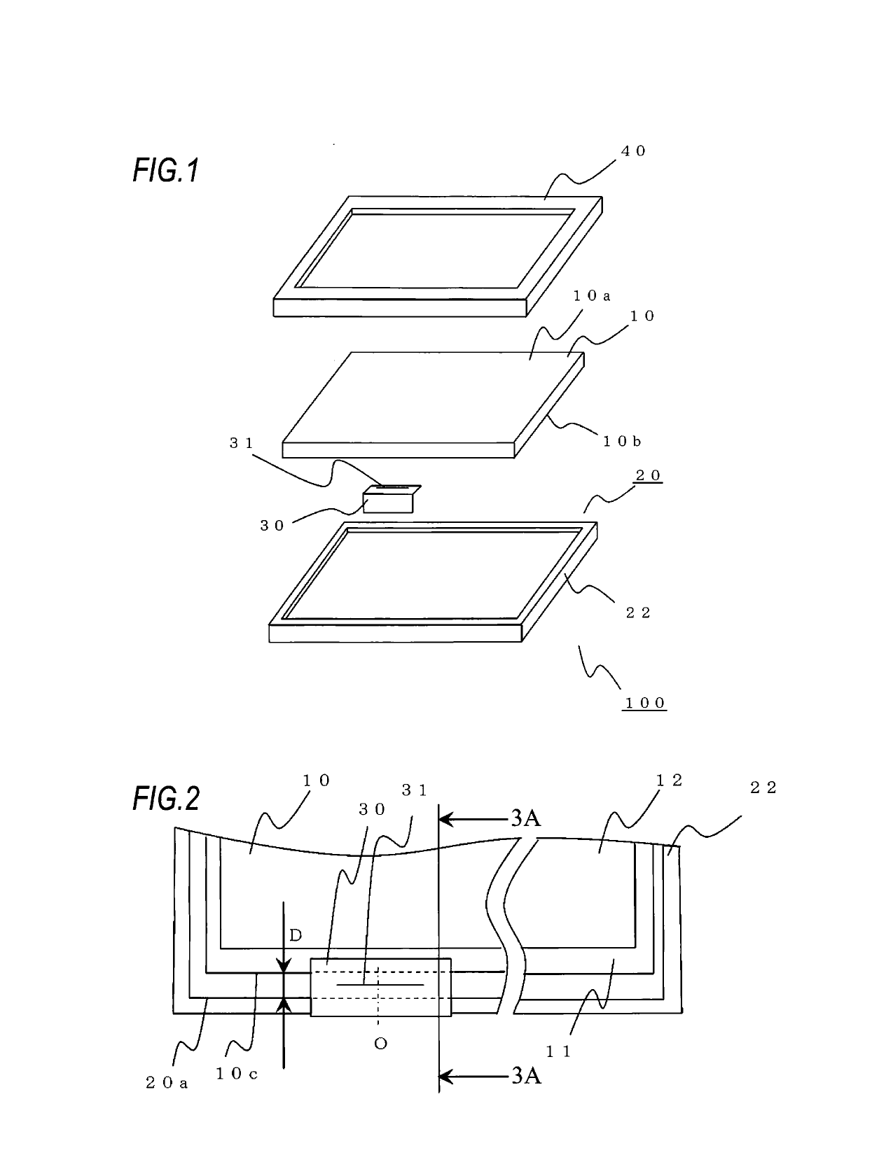

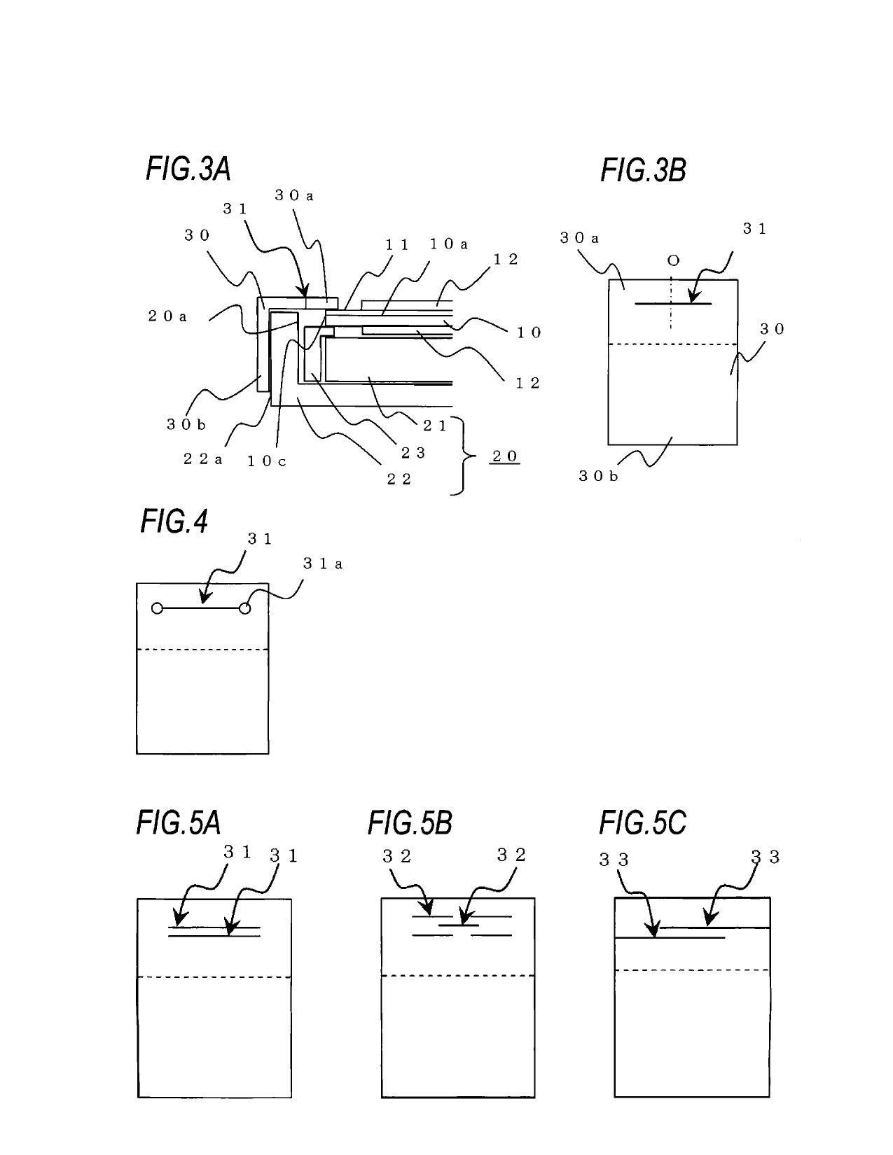

FIG. 1 is an exploded perspective view illustrating a liquid crystal display apparatus of an in-plane switching type according to an illustrative embodiment of this disclosure, FIG. 2 is a front view illustrating the liquid crystal display apparatus of this disclosure, FIG. 3A is a sectional view illustrating the liquid crystal display apparatus of FIG. 2, which is taken along a line III-III, and FIG.3B is a front view illustrating a conductive tape and FIG. 4 is a front view illustrating the conductive tape used in the liquid crystal display apparatus of this disclosure.

As shown in FIGS. 1 to 3, a liquid crystal display apparatus 100 of an in-plane switching type according to an illustrative embodiment of this disclosure includes a liquid crystal display panel 10 of an in-plane switching type serving as a display device and a backlight 20 that is arranged on a backside 10b opposite to a display surface 10a of the liquid crystal display panel 10 and illuminates the liquid crystal display panel 10 from the backside 10b.

As shown in FIG. 3A, the backlight 20 includes a light source (not shown) that emits light, a light guide plate 21 that propagates the light emitted from the light source, an optical sheet (not shown) that regulates a direction and the like of the light propagated by the light guide plate 21, and the like, and has a metal case 22 made of a material including metal accommodating the above members. The backlight may also have a middle case 23 so as to hold the light guide plate 21 and the like.

The liquid crystal display panel 10 is arranged on the backlight 20. An upper case 40 shown in FIG. 1 is arranged so as to engage the backlight 20 and the liquid crystal display panel 10. The upper case 40 has an opening through which the light emitted from the backlight 20 penetrates and is configured so that the light is not leaked to an outside from the other parts except for the opening. The upper case 40 may be made of a metal material such as aluminum, stainless, iron and the like and a resin material such as PC (polycarbonate), ABS (acrylonitrile butadiene styrene) and the like.

The liquid crystal display panel 10 used in this disclosure uses a birefringence property of a liquid crystal. The liquid crystal display panel includes an opposite substrate that has a coloring layer, a light shield layer and the like formed on an insulating substrate such as glass and a TFT array substrate that has thin film transistors (TFTs) becoming switching devices, pixel electrodes, opposite electrodes and the like formed on an insulating substrate such as glass, which are not shown. The liquid crystal display panel also has a spacer for maintaining a gap between the opposite substrate and the TFT array substrate, a seal material for adhering the opposite substrate and the TFT array substrate, liquid crystals that are held between the opposite substrate and the TFT array substrate, a sealing material for an injection port through which the liquid crystals are injected and an orientation film (not shown) for light-distributing the liquid crystals, and a polarization plate 12 and the like are arranged thereon. In the liquid crystal display panel 10 of an in-plane switching type of this disclosure, an electric field is applied to the TFT array substrate in a horizontal direction. Since the pixel electrodes and the opposite electrodes are formed on the same TFT array substrate, the static electricity is apt to be charged to the opposite substrate on which no electrode is formed.

Like this, when the static electricity is charged to the display surface 10a of the liquid crystal display panel 10, the orientation of the liquid crystals is distracted to cause a display defect. Hence, it is required to discharge the static electricity of the liquid crystal display panel 10.

As shown in FIG. 3A, a conductive film 11 is formed on the display surface 10a side, which is the opposite substrate side of the liquid crystal display panel 10 of an in-plane switching type of this disclosure, and a polarizing plate 12 is arranged on a surface of the conductive film so that a part of the conductive film 11 is exposed. A conductive tape 30 is attached so that it extends over an end portion of the conductive film 11 on the display surface 10a of the liquid crystal display panel 10 and the metal case 22 that is a constitutional member of the backlight 20. According to this configuration, the static electricity that is charged to the display surface 10a of the liquid crystal display panel 10 is discharged toward the backlight 20.

The conductive tape 30 is a conductive tape having an adhesive material that is formed by stacking an adhesive layer including a conductive material on one surface of a metal foil such as copper foil and aluminum foil. As shown in FIG. 3, the conductive tape 30 has one end portion 30a that is adhered to the conductive film 11 formed on the display surface 10a of the liquid crystal display panel 10 and the other end portion 30b that is adhered to one surface of the metal case 22, in this illustrative embodiment, an outer side surface 22a.

As shown in FIGS. 2 and 3, the conductive tape 30 used in this disclosure is formed with a straight slit portion 31. The slit portion 31 is a linear opening that is formed to extend in a direction parallel with an end portion 10c of the liquid crystal display apparatus 10 and to be substantially symmetrical from a central portion O of the conductive tape 30 (the central portion O is a center of the slit portion). The conductive tape 30 is disposed so that the slit portion 31 is parallel with the end portion 10c of the liquid crystal display apparatus 10. In the meantime, the conductive tape 30 has a substantially rectangular shape. Also, the slit portion 31 may have a curved line or a straight line having an angle, as required.

A method of assembling the liquid crystal display apparatus 100 of this disclosure is described. As shown in FIGS. 1 to 3, the liquid crystal display panel 10 is first arranged at an emission surface side of the backlight 20, and then the conductive tape 30 is adhered over the liquid crystal display panel 10 and the backlight 20. The one end portion 30a of the conductive tape 30 is adhered to the conductive film 11 formed on the display surface 10a of the liquid crystal display panel 10 and the other end portion 30b thereof is adhered to the outer side surface 22a that is one surface of the metal case 22. At this time, the slit portion 31 provided to the conductive tape 30 is arranged in a gap (clearance) D between the end portion 10c of the liquid crystal display panel 10 and an end portion 20a of the backlight 20, which is arranged to face the end portion 10c of the liquid crystal display panel 10. Also, the slit portion 31 is arranged to be parallel with the end portion 10c of the liquid crystal display panel 10. That is, the slit portion 31 is arranged so that it is not adhered to any one of the constitutional members of the liquid crystal display panel 10 and the backlight 20. Then, the upper case 40 is covered from the display surface 10a side so that it covers the metal case 22 accommodating the backlight 20 therein. Thereby, the backlight 20 and the liquid crystal display panel 10 are engaged.

According to the above configuration, when the liquid crystal display panel 10 is moved from a predetermined position, the conductive tape 30 is also applied with stress in the same moving direction as the liquid crystal display panel 10, so that the stress may be applied between the liquid crystal display panel and the adhesion position of the conductive tape 30 at the backlight 20 side. Like this, the stress is transferred to the conductive tape 30, so that the conductive tape 30 is moved in a direction of peeling off from the liquid crystal display panel 10 (or backlight 20 side). However, the conductive tape 30 used in the liquid crystal display apparatus 100 of this disclosure is formed with the straight slit portion 31, as a stress absorption part, in the gap (clearance) D between the end portion 10c of the liquid crystal display panel 10 and the end portion 20a of the backlight 20, which is arranged to face the end portion 10c of the liquid crystal display panel 10. Therefore, when the stress is applied to the conductive tape 30, the slit portion 31 is opened and widened, so that it absorbs the applied stress to thus prevent the stress that is applied in the peeling off direction of the conductive tape 30. According to this configuration, the stress that is transferred to the conductive tape 30 due to the stress applied to the liquid crystal display panel 10 is reduced, so that the conductive tape 30 is prevented from being peeled off.

As described above, according to the liquid crystal display apparatus 100 of the first illustrative embodiment, the slit portion 31, which is the stress absorption part formed at the conductive tape 30 for discharging the static electricity to be charged to the display surface 10a of the liquid crystal display panel 10 of the in-plane switching type, is arranged in the gap (clearance) D between the end portion 10c of the liquid crystal display panel 10 and the end portion 20a of the backlight 20, which is arranged to face the end portion 10c of the liquid crystal display panel 10. Therefore, it is possible to prevent the conductive tape 30 from being peeled off due to the stress transferred to the conductive tape 30 from the liquid crystal display panel 10. Hence, the problem that the orientation of the liquid crystals is distracted due to the charging of the liquid crystal display panel 10, which is caused due to the peeling off of the conductive tape 30, is prevented to thus reduce the display defects.

In the meantime, the liquid crystal display apparatus of this disclosure realizes the above effects just by forming the slit portion 31 at the conductive tape 30 without reinforcing the conductive tape 30 or without performing a chemical process for improving the adhesion force. Therefore, the number of assembling processes, the number of parts and the manufacturing cost such as material cost are not increased.

FIG. 4 is a modified embodiment of the first illustrative embodiment and is a plan view illustrating the conductive tape 30. As shown in FIG. 4, in this modified embodiment, the slit portion 31 provided to the conductive tape 30 has small circular holes 31a at both ends thereof. Therefore, when the slit portion 31 is opened to absorb the stress applied to the conductive tape 30, the stress is further reduced by the small circular holes 31a, so that the conductive tape 30 is prevented from being peeled off and the slit portion 31 is prevented from being fractured at both ends thereof.

FIGS. 5A to 5C show the other modified embodiments of the first illustrative embodiment and are plan views of the conductive tape 30. As shown in FIG. 5A, in this modified embodiment, a plurality of slit portions 31 is formed at the conductive tape 30. As described above with reference to FIGS. 2 and 3, the straight slit portions 31 are arranged in parallel to face each other in the gap (clearance) D between the end portion 10c of the liquid crystal display panel 10 and the end portion 20a of the backlight 20, which is arranged to face the end portion 10c of the liquid crystal display panel 10. When the plurality of slit portions 31 is formed, like this modified embodiment, a deformation amount of the slit portions 31 is increased, compared to the configuration where only one slit portion 31 is formed at the conductive tape 30. Therefore, the stress to be absorbed is increased and can be dispersed and absorbed. As a result, it is possible to further prevent the conductive tape 30 from being peeled off.

In the meantime, even when one slit portion 31 is arranged and adhered at the end portion 10c of the liquid crystal display panel 10 or at the constitutional member (for example, at the upper part of the metal case 22) of the backlight 20, the effects of the first illustrative embodiment can be realized if any one slit portion 31 is arranged (with not being adhered) in the gap (clearance) D between the end portion 10c of the liquid crystal display panel 10 and the end portion 20a of the backlight 20, which is arranged to face the end portion 10c of the liquid crystal display panel 10. By forming the plurality of slit portions 31 at the conductive tape 30, it is possible to improve the assembling capability.

Also, as shown in FIG. 5B, a plurality of slit portions 32 may be arranged in a zigzag lattice shape. One slit portion 32 is formed at a central portion and four slit portions 32 are formed in parallel around the central slit portion 32. Also, the plurality of slit portions 32 is arranged in the gap (clearance) D between the end portion 10c of the liquid crystal display panel 10 and the end portion 20a of the backlight 20, which is arranged to face the end portion 10c of the liquid crystal display panel 10. Like this, when the plurality of slit portions 32 is arranged in a zigzag lattice shape, it is possible to further increase the deformation amount of the slit portions 32, compared to the configuration where the plurality of slit portions 31 having the same shape is arranged in parallel and to face each other. Therefore, the stress to be absorbed is increased and can be dispersed and absorbed.

Also, as shown in FIG. 5C, a plurality of slit portions 33 having one end extending to the end portion of the conductive tape 30 may be formed, other than the straight slit portion 31 that is substantially symmetrical from the center. When the slit portions 33 having such shape are formed at the conductive tape 30, the one end portions of the slit portions 33 extend to the end portions of the conductive tape 30, so that it is possible to further increase the deformation amount of the slit portions 33, compared to the configuration where one end portion of the slit portion does not extend to the end portion of the conductive tape 30. Therefore, it is possible to disperse the stress and to absorb the same by the openings of the slit portions 33.

### Second Illustrative Embodiment

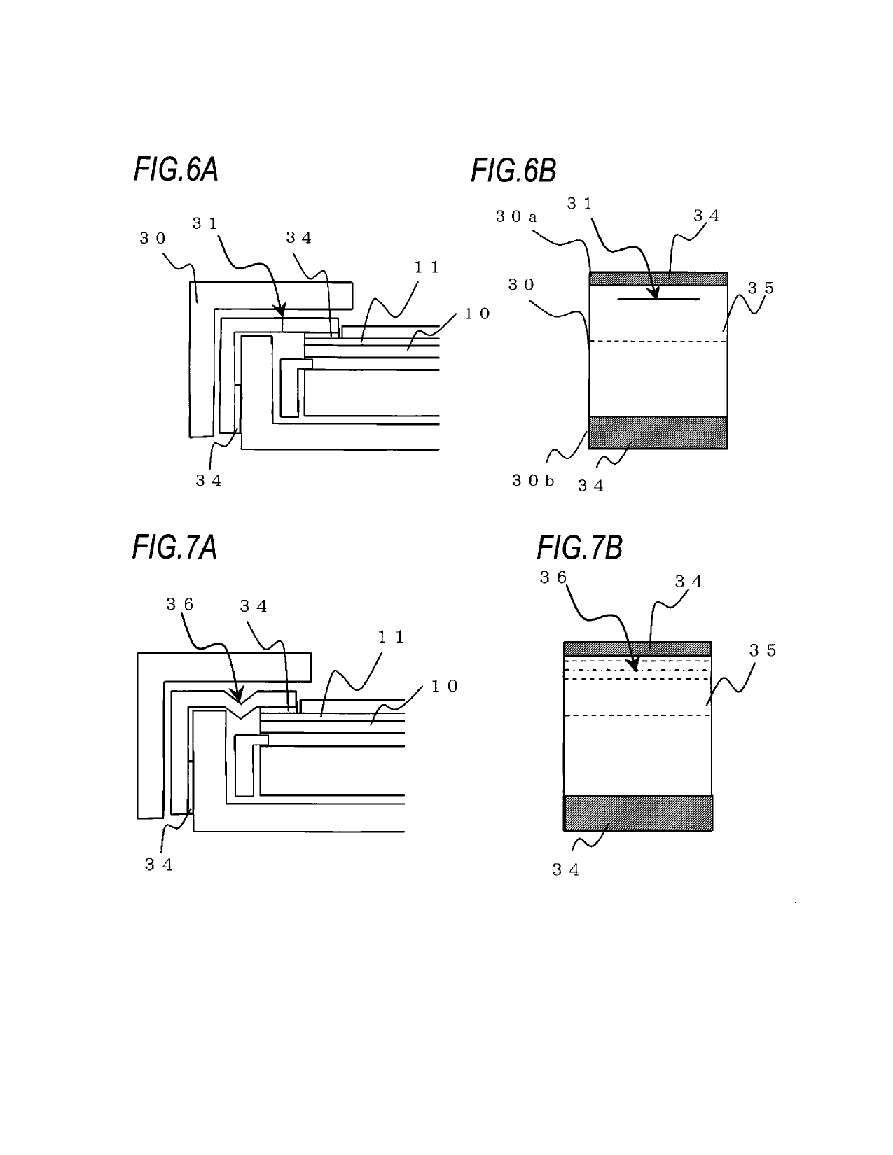

FIG. 6A is a sectional view illustrating a liquid crystal display apparatus of a second illustrative embodiment and FIG. 6B is a backside view illustrating the conductive tape 30 that is arranged in the liquid crystal display apparatus of FIG. 6A. According to the liquid crystal display apparatus of the first illustrative embodiment, the one end portion 30a of the conductive tape 30 having the adhesive material on one entire surface thereof is adhered to the conductive film 11 on the display surface 10a of the liquid crystal display panel 10 and the other end portion 30b is adhered to the outer side surface 22a of the metal case 22. At that time, the slit portion 31 provided to the conductive tape 30 is arranged in the gap (clearance) D between the end portion 10c of the liquid crystal display panel 10 and the end portion 20a of the backlight 20, which is arranged to face the end portion 10c of the liquid crystal display panel 10. According to the liquid crystal display apparatus of the second illustrative embodiment, an area of the adhesive material arranged on one surface of the conductive tape 30 is limited. As shown in FIGS. 6A and 6B, the conductive tape 30 is provided with adhesion parts 34 having the adhesive materials that are arranged at the end portion 30a to be adhered to the liquid crystal display panel 10 and at the end portion 30b to be adhered to the backlight 20 and a non-adhesion part 35 that is an area except for the adhesion parts 34. Also, the slit portion 32 is provided at the non-adhesion part 35. Meanwhile, the liquid crystal display apparatus of the second illustrative embodiment realizes the same effects as those of the first illustrative embodiment, except for specific effects of the second illustrative embodiment. Thus, the descriptions thereof are omitted.

As shown in FIGS. 6A and 6B, the conductive tape 30 has the slit portion 31 as the stress absorption part, and is provided with the adhesion parts 34 having the adhesive materials that are arranged at the end portion 30a to be adhered to the liquid crystal display panel 10 and at the end portion 30b to be adhered to the backlight 20 and the non-adhesion part 35 that is an area except for the adhesion parts 34. The non-adhesion part 35 is provided, so that it is possible to make it difficult for the stress, which is applied to the conductive tape 30, to be transferred.

According to the above configuration, since the non-adhesion part 35 is provided in addition to the slit portion 31 of the conductive tape 30, it is possible to absorb the stress, which is applied to the conductive tape 30, at the slit portion 31 and the non-adhesion part 35.

FIG. 7A is a sectional view illustrating a liquid crystal display apparatus of a modified embodiment of the second illustrative embodiment and FIG. 7B is a backside view illustrating the conductive tape 30 that is arranged in the liquid crystal display apparatus of FIG. 7A. As shown in FIGS. 7A and 7B, the conductive tape 30 of this modified embodiment is formed with a folded portion 36, instead of the slit portion 31. The folded portion 36 that is convex toward the inside of the backlight 20 is formed in the gap (clearance) D between the end portion 10c of the liquid crystal display panel 10 and the end portion 20a of the backlight 20, which is arranged to face the end portion 10c of the liquid crystal display panel 10, and at the non-adhesion part 35. In the meantime, the folded portion 36 is formed to be convex toward the inside of the backlight 20. However, the folded portion may be formed to be convex toward the outside of the backlight 20.

In this modified embodiment, the conductive tape 30 is formed with the folded portion 36 at the non-adhesion part 35, instead of the slit portion 31. Thus, when the stress is applied, the folded portion 36 is enlarged to absorb the stress.

Therefore, it is possible to absorb the stress, which is applied to the conductive tape 30, at the folded portion 36 and the non-adhesion part 35.

In the meantime, the slit portion 31 or folded portion 36 serving as the stress absorption part can realize the same effects even when it is provided at the adhesion part 34. When it is provided in the adhesion part 34, so that it is possible to increase the degree of design freedom of positions for providing the stress absorption part.

### Third Illustrative Embodiment

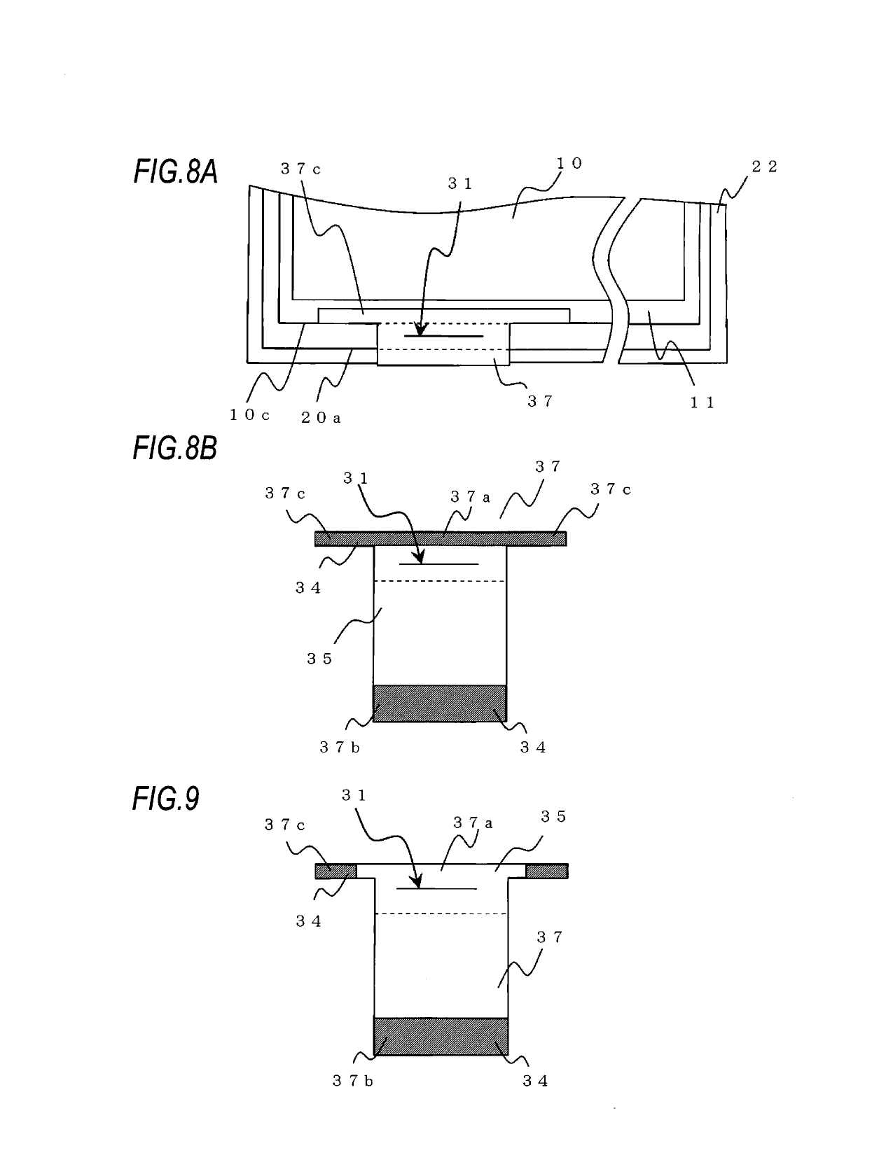

FIG. 8A is a front view illustrating a liquid crystal display apparatus of a third illustrative embodiment, and FIG. 8B is a backside view illustrating a conductive tape 37 arranged in the liquid crystal display apparatus of FIG. 8A. The conductive tape 37 that is used in the third illustrative embodiment has a T-shape having protrusions 37c, in which adhesion parts to be arranged at the end portion 10c of the liquid crystal display panel 10, protrude in a direction extending along the end portion 10c, as shown in FIG. 8. Meanwhile, the liquid crystal display apparatus of the third illustrative embodiment realizes the same effects as those of the first and second illustrative embodiments, except for specific effects of the third illustrative embodiment. Thus, the descriptions thereof are omitted.

As shown in FIG. 8, an end portion 37a of the conductive tape 37 that is used in the third illustrative embodiment, which is arranged at the liquid crystal display panel 10 side, has the protrusions 37c that protrude along the end portion 10c of the liquid crystal display panel 10. In the third illustrative embodiment, the conductive tape 37 has an adhesion part 34 at the end portion 37a including the protrusions 37c and is adhered to the conductive film 11 at the end portion 10c of the liquid crystal display panel 10. In the meantime, an end portion 37b that is arranged at the backlight side is also provided with the adhesion part 34, so that the conductive tape is adhered to the constitutional member (not shown) of the backlight.

The conductive tape 37 has the protrusions 37c and the end portion 37a including the protrusions 37c is adhered to the conductive film 11 at the end portion 10c of the liquid crystal display panel 10, so that the contact area between the liquid crystal display panel 10 and the conductive tape 37 is increased. Thus, it is possible to reduce the stress per unit area, which is applied to the adhesion part 34 on the liquid crystal display panel 10, thereby preventing the conductive tape 37 from being peeled off. In the meantime, likewise the second illustrative embodiments, the slit portion 31, the adhesion parts 34 that are provided at the end portion 37a to be adhered to the liquid crystal display panel 10 and at the end portion 37b to be adhered to the backlight 20, and a non-adhesion part 35 except for the adhesion parts 34 are provided, so that the stress to be applied to the conductive tape 37 can be absorbed.

FIG. 9 is a backside view illustrating the conductive tape 37 of a modified embodiment of the third illustrative embodiment. As shown in FIG. 9, the adhesion parts 34 are provided only at the protrusions 37c of the end portion 37a of the conductive tape 37 to be arranged at the liquid crystal display panel 10 side. Thereby, an area of the non-adhesion part 35 is increased. According to this configuration, it is possible to make it difficult for the stress to be transferred to the conductive tape 37. Also, since the adhesion parts 34 of the conductive tape 37 are alternately arranged, it is possible to reduce the stress that is applied to the adhesion parts 34 of the conductive tape 37, thereby preventing the conductive tape 37 from being peeled off.

The liquid crystal display apparatus of this disclosure can be configured by combining the respective embodiments and can be appropriately changed without departing from the effects of this disclosure.

What is claimed is:

1. A liquid crystal display apparatus comprising:
a liquid crystal display panel, which is an in-plane switching type and has liquid crystals sealed between two insulating substrates to be applied a horizontal electric field to the liquid crystals;
a conductive film that is formed on a display surface side of the liquid crystal display panel;
a backlight that illuminates the liquid crystal display panel from a backside that is opposite to the display surface; and
a conductive tape that is adhered over the conductive film and a metal member configuring the backlight,
wherein the conductive tape has a stress absorption part that is provided between an end portion of the liquid crystal display panel and an end portion of the backlight, which is arranged to face the end portion of the liquid crystal display panel, to absorb stress to be applied to the conductive tape.

2. The liquid crystal display apparatus according to claim 1,
wherein the stress absorption part is a slit portion formed at the conductive tape, and
wherein the slit portion is a straight opening parallel with the end portion of the liquid crystal display panel.

3. The liquid crystal display apparatus according to claim 2,
wherein the conductive tape has a plurality of the slit portions.

4. The liquid crystal display apparatus according to claim 2,
wherein the slit potion of the conductive tape has small circular holes at both ends thereof.

5. The liquid crystal display apparatus according to claim 1,
wherein the stress absorption part is a folded portion that is formed by folding the conductive tape.

6. The liquid crystal display apparatus according to claim 1,
wherein the conductive tape has a protrusion that protrudes in a direction extending along an end portion to be arranged at the liquid crystal display panel side.

7. The liquid crystal display apparatus according to claim 2,
wherein the conductive tape has adhesion parts in areas to be adhered to the conductive film and the metal member, and
wherein the stress absorption part is provided to a non-adhesion part of an area except for the adhesion parts.

8. The liquid crystal display apparatus according to claim 5,
wherein the conductive tape has adhesion parts in areas to be adhered to the conductive film and the metal member, and
wherein the stress absorption part is provided to a non-adhesion part of an area except for the adhesion parts.
